(19) United States
(12) Patent Application Publication
(10) Pub. No.: US 2023/0082134 A1
(43) Pub. Date: Mar. 16, 2023

(54) AUTOMATED PARKING SYSTEMS

(71) Applicant: Municipal Parking Services, Inc., Minnetonka, MN (US)

(72) Inventors: James MARTIN, Minneapolis, MN (US); Mark J. MORAN, Woodbury, MN (US); Richard W. KELLEY, II, Eagan, MN (US); David E. COLLINS, Monument, CO (US); Tyler TRETSVEN, New Hope, MN (US); Steven B. LANE, Maple Grove, MN (US); Christopher W. BALDWIN, St. Paul, MN (US)

(21) Appl. No.: 17/946,930

(22) Filed: Sep. 16, 2022

Related U.S. Application Data
(60) Provisional application No. 63/245,177, filed on Sep. 16, 2021.

(51) Int. Cl. G06V 20/62; G06V 10/20; G06V 10/56; G06F 3/16; G06Q 50/30

(52) U.S. Cl. CPC G06V 20/625; G06V 10/255; G06V 10/56; G06F 3/16; G06Q 50/30; G06V 2201/08

(57) ABSTRACT

Disclosed are devices, systems and methods for automating parking for a parking facility. Cameras are used to perform a license plate recognition (LPR) readings of vehicles entering and exiting the parking facility. When a match of the LPR reading of a vehicle exiting the facility to any of the vehicles that have entered the facility cannot be found, a secondary identification analysis is performed. The secondary identification analysis can include performing a shape recognition and/or color recognition of still images of the vehicles as they entered and exited the parking facility to find a vehicle match.

### PRIORITY

This Application claims priority to and the benefit of U.S. Provisional Patent Application No. 63/245,177, filed Sep. 16, 2021, which is incorporated fully herein by reference.

### FIELD

The present invention relates generally to parking systems and, more particularly, to systems and methods for automation of parking facilities such as parking lots and parking ramps.

### BACKGROUND

Automated parking management systems for parking lots and ramps are disclosed, for example, in U.S. Pat. No. 10,121,172 B2 (which is incorporated herein by reference in its entirety). Such systems utilize license plate recognition (LPR) to read a license plate of each vehicle entering and exiting the parking facility.

In order to establish a “parking session,” the vehicle's plate is “read” by a camera utilizing LPR upon the vehicle's entrance to the parking facility. This allows the parking management system to add to the occupancy tally of vehicles in the facility and to time the vehicle's occupancy duration in the facility for accurate charging of parking time.

The parking session ends when the vehicle's plate is again read by a camera at the exit of the facility using LPR. This allows the parking management system to subtract the vehicle from the occupancy tally of vehicles in the facility and to calculate the charge for parking time spent in the parking facility.

Current LPR techniques are not 100% accurate. Many factors such as lighting, faded or old plates, reflective plates, plate covers, partially blocked plates, and the presence of bike racks, trailer hitches, trailers on hitches, vanity plates (icons), stickers, clear or dark shields over the plates, etc. can contribute to incorrect LPR readings or the inability to perform any reading (non-readings). In addition, temporary license stickers in vehicle windows typically cannot be read by conventional LPR cameras.

If there is an error in the LPR process at either the entrance or exit reading of a vehicle's plate, then the vehicle exiting the facility will not be able to match to any vehicle that entered the parking facility. For example if the entry reading is interpreted as Plate 123XYZ by the LPR camera and the exit is interpreted as Plate IZ3XY, then the parking session for 123XYZ will remain open and a parking charge for IZ3XY cannot be calculated because there was no parking session created for IZ3XYZ, and thus, no start time to serve as a basis for calculations. Moreover, the parking occupancy tally cannot be correctly updated to reflect that the previously parked vehicle had exited the parking facility.

LPR errors can also present a problem when identifying vehicles entering a parking lot that must identify permit parking or pass holders. For example, a person may purchase a monthly permit to park in a particular parking facility. Their vehicle's license plate can be stored in a database so that the parking system recognizes the permitted vehicle upon entrance to the parking facility. If the vehicle's license plate is not correctly read, then that vehicle will not be noted as a permit holder and the vehicle may be flagged for a parking violation or denied entry into the parking facility.

Therefore, there is a need to provide a parking management system that can address LPR errors that occur with automated parking systems.

### SUMMARY

Disclosed are devices, systems and methods for automating parking management for a parking facility. Cameras are used to perform license plate recognition (LPR) readings of vehicles entering and exiting the parking facility. When a match of the LPR reading of a vehicle exiting the facility to any of the vehicles that have entered the facility cannot be found, a secondary identification analysis is performed. The secondary identification analysis can include performing a shape recognition and/or color recognition of still images of the vehicles as they entered and exited the parking facility to find a vehicle match. Additional features and aspects of various embodiments are described more fully herein below and in the appended figures.

An automated parking system for a parking facility comprising an entrance and an exit is disclosed. In one example embodiment, the automated parking system comprises a first license plate recognition (LPR) camera device disposed adjacent to the entrance of the parking facility, a second LPR camera device disposed adjacent to the exit of the parking facility, and a control computer located remote from the first LPR camera device and the second LPR camera device, the control computer networked with the first LPR camera device and the second LPR camera device. The first LPR camera device is configured to read a license plate of a vehicle entering the parking facility. The second LPR camera device is configured to read a license plate of the vehicle exiting the parking facility. At least one of the control computer, the first LPR camera device and the second LPR camera device comprise a parking database to store for every vehicle entering the parking facility the reading of the license plate of the vehicle entering the parking facility, the reading of the vehicle exiting the parking facility, an image of the vehicle entering the parking facility and an image of the vehicle exiting the parking facility. At least one of the control computer, the first LPR camera device and the second LPR camera device is configured to attempt to compare the reading of the license plate of the vehicle exiting the parking facility to the stored readings of the license plates of vehicles entering the parking facility to find a matching license plate reading. When no match of the license plate reading of the vehicle exiting the parking facility to the stored readings of the license plates of vehicles entering the parking facility can be found, at least one of the control computer, the first LPR camera device and the second LPR camera device further configured to compare the image of the vehicle exiting the parking facility to the stored images of the vehicles entering the parking facility to find a matching vehicle shape and/or color.

When no match of the shape and/or color of the vehicle exiting the parking facility can be found, at least one of the control computer, the first LPR camera device and the second LPR camera device can be further configured to flag for human review a parking session corresponding to the vehicle entering the parking facility.

When the license plate reading by the first LPR camera device produces a non-read result, at least one of the control computer, the first LPR camera device and the second LPR camera device can be further configured to fill in a license plate reading data field in the parking database corresponding to the vehicle entering the parking facility with the license plate reading by the second LPR camera device when the shape and/or color of the vehicle exiting the parking facility can be found in the parking database.

When the license plate reading by the second LPR camera device produces a non-read result, at least one of the control computer, the first LPR camera device and the second LPR camera device can be further configured to fill in a license plate reading data field in the parking database corresponding to the vehicle exiting the parking facility with the license plate reading by the first LPR camera device when the shape and/or color of the vehicle exiting the parking facility can be found in the parking database.

When the license plate reading by both of the first LPR camera device and the second LPR camera device produces a non-read result, at least one of the control computer, the first LPR camera device and the second LPR camera device can be further configured to flag for human review a parking session corresponding to the vehicle entering the parking facility.

When either of the license plate reading by the first LPR camera device and/or the second LPR camera device produces a non-read result, at least one of the first LPR camera device and the second LPR camera device can be further configured to provide an audible prompt to the vehicle to manually enter license plate data for the vehicle.

At least one of the control computer, the first LPR camera device and the second LPR camera device can be further configured to compare the reading of the license plate of the vehicle entering the parking facility to stored readings of license plates of vehicles stored in a parking permit database.

At least one of the control computer, the first LPR camera device and the second LPR camera device can be further configured to compare the reading of the license plate of the vehicle entering the parking facility to stored vehicle data from a government department of vehicle registration records to verify that the shape and/or color of the vehicle entering the parking facility matches the official government record for the vehicle entering the parking facility.

At least one of the control computer, the first LPR camera device and the second LPR camera device can be further configured to calculate a parking fee for a parking duration from a time that the vehicle entered the parking facility to a time that the vehicle exited the parking facility.

The first LPR camera device can be configured to capture a still image of the vehicle entering the parking facility and the second LPR camera device can be configured to capture a still image of the vehicle exiting the parking facility.

Either or both of the LPR camera devices can be configured as bollards with a camera disposed inside of the bollard.

A kiosk can be disposed in the parking facility and networked with the control computer, and located remote from the first LPR camera device and the second LPR camera device.

A method of automating monitoring of vehicles entering and exiting the parking facility is also disclosed. In one example, the method comprises reading a license plate of each of the vehicles entering the parking facility with a first LPR camera, capturing a still image of each of the vehicles entering the parking facility, storing in a parking database for each vehicle entering the parking facility the license plate reading and the still image corresponding to each vehicle, reading a license plate of each of the vehicles exiting the parking facility with a second LPR camera, capturing a still image of each of the vehicles exiting the parking facility. For each vehicle exiting the parking facility, the vehicle's license plate reading is compared by the second LPR camera with the license plate readings for the vehicles entering the parking facility stored in the parking database to find a matching license plate reading. When a match of license plate readings is found, it is stored in the parking database for the vehicle corresponding to the matching license plate reading, the license plate reading for the vehicle exiting the parking facility and the still image for the vehicle exiting the parking facility. When a match of license plate readings is not found, the system compares the still image of the vehicle exiting the parking facility with the still images captured for the vehicles entering the parking facility that were stored in the parking database to find a matching still image.

When no match of the still image to the parking database can be found, a parking session corresponding to the vehicle exiting the parking facility whose still image produced no matches can be flagged for human review.

When the license plate reading by the first LPR camera device produces a non-read result, a license plate reading data field in the parking database corresponding to the vehicle entering the parking facility whose license plate reading produced the non-read result can be filled in when the still image of the vehicle exiting the parking facility matches the still image of the vehicle entering the parking facility.

The step of comparing the still image of the vehicle exiting the parking facility with the still images captured for the vehicles entering the parking facility stored in the parking database to find a matching still image can comprise performing an automated machine analysis of a color and/or a shape of the vehicle depicted in each of the still images.

When the license plate reading of both a vehicle entering and exiting the parking facility produces a non-read result, the corresponding parking session can be flagged for human review.

When either of the license plate readings produces a non-read result, an audible prompt to the vehicle to manually enter license plate data for the vehicle can be provided.

A control computer system networked with the first LPR camera and the second LPR camera can read the license plate of the vehicle entering the parking facility and can compare the read license plate data with stored readings of license plates of vehicles in a parking permit database.

A control computer system networked with the first LPR camera and the second LPR camera can compare the reading of the license plate of each vehicle entering the parking facility to stored vehicle data from a government department of vehicle registration records to verify that the shape and/or color of a given vehicle entering the parking facility matches the official government record for that vehicle.

A parking fee for a parking duration can be calculated from a time that a given vehicle entered the parking facility to a time that the given vehicle exited the parking facility.

The above summary is not intended to limit the scope of the invention, or describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a diagram of a vehicle license plate being read by a LPR camera as the vehicle passes by the camera device according to certain example embodiments.

FIG. 2 is a diagram of a parking lot monitoring system according to certain example embodiments.

FIG. 3 is a diagram of a parking lot monitoring system according to certain example embodiments.

FIG. 4 is a diagram of a parking lot monitoring system according to certain example embodiments.

FIG. 5 is a diagram of a parking lot monitoring system according to certain example embodiments.

FIG. 6 is a perspective view of a camera bollard for a parking lot monitoring system according to certain example embodiments.

FIG. 7 is a front view of a kiosk for a parking lot monitoring system according to certain example embodiments.

FIG. 8 is a block diagram of certain components of a parking lot monitoring system according to certain example embodiments.

FIGS. 9A-9B are a flowchart of parking monitoring steps or functions according to certain example embodiments.

FIG. 10 is an example database structure for a parking session for vehicles in a parking facility according to certain example embodiments.

FIG. 11 is an example database structure for a parking session for vehicles in a parking facility according to certain example embodiments.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

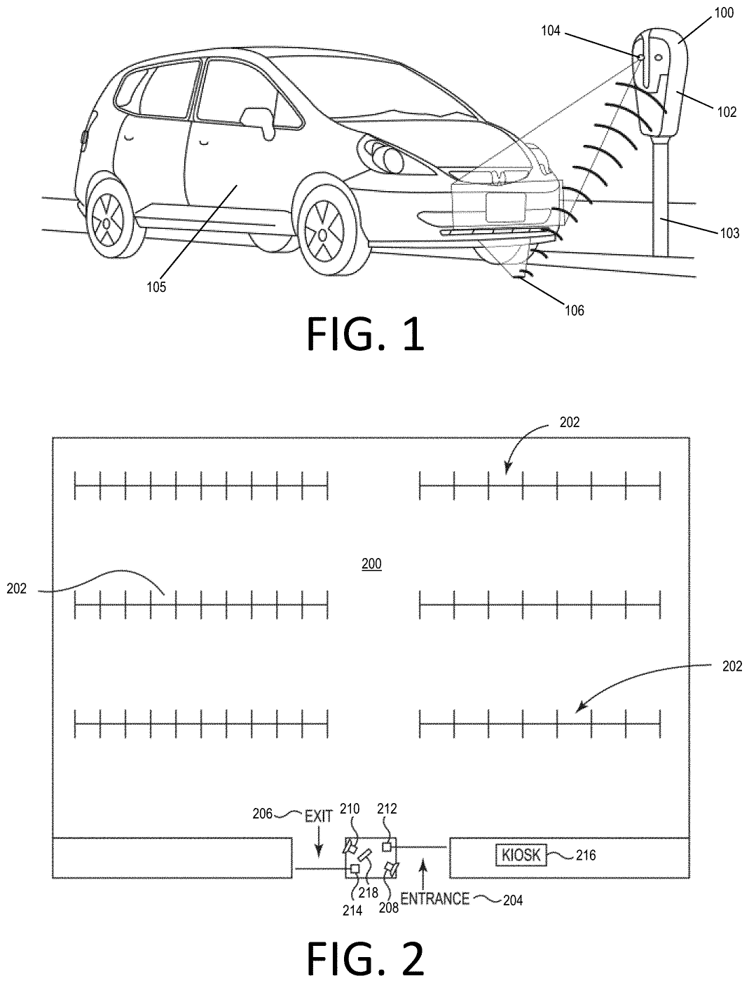

Referring to FIG. 1, in certain embodiments, one or more LPR camera devices 100 are enclosed in a camera housing 102 that can be placed adjacent to the entrance or exit of a parking facility (e.g. parking lot, parking ramp or other types of parking structure). The camera housing 102 can be disposed atop a pole 103 that is secured to the ground, or the camera housing 102 can be configured as a bollard or other suitable configuration in other embodiments.

One or more cameras 104 are disposed inside of the housing 102. The camera(s) 104 can view outward through a window in the housing or directly from the housing 102. The camera(s) can also be mounted external to the housing. The camera(s) can also be mounted on a pole separate from the housing 102.

Also enclosed with the housing 102 are microprocessor(s), memory and computer code that enable the LPR camera devices 100 to read the license plates of vehicles 105 entering or exiting the parking facility, as well as obtain still images and/or video of the vehicles 105. A computer readable program code can be stored in the physical memory (e.g., random access memory, flash memory or hard-drive) of the LPR camera devices 100. The computer readable program code is configured such that when executed by the microprocessor, the code causes the LPR camera device (and other system components described herein) to perform the LPR function and perform other the steps of the invention described herein.

In certain embodiments, a vehicle sensor 106 can be embedded in the ground below, on the pole 103, in the housing 102, or somewhere adjacent to, the vehicle 105. The vehicle sensor 106, such as a magnetic sensor, a radar sensor, sonic sensor or laser sensor, can be used to detect the presence of a vehicle to serve as a double-check on a vehicle detection function of the LPR camera device 100, or it can serve as a low-power sensor to wake up the LPR camera device 100 from a dormant or power-conserving state. The vehicle sensor 106 can also be a second camera.

The vehicle sensor 106 broadcasts a status message or output value to the nearby LPR camera device 100 as shown in FIG. 1. The broadcast can be performed using low power Bluetooth or other short range wireless communications protocol. The broadcast frequency can be continuous or periodic. For example, the status of the vehicle sensor 106 can be broadcast once per second, ten times per second, etc.

In one preferred embodiment, the vehicle sensor 106 is powered by an internal lithium-based battery and a sensing/broadcast cycle is performed once per second in order to conserve battery life. A sensor life expectancy of several years can be achieved using such battery and operating method. In other embodiments, the sensor can be hard-wired for power and/or broadcast.

In embodiments where the vehicle sensor 106 is integrated into, or located adjacent to, the LPR camera device 100, the sensor 106 can be coupled to the LPR camera device 100 via internal wires (if internal) or via an electrical conduit (if external). The conduit can carry both power and data bi-directionally, or separate power and data conduits can be provided. More than one vehicle sensor 106 can also be employed.

The camera or cameras 104 disposed in the LPR camera device 100 (or remotely from the housing 102 as discussed above) use image sensors (e.g. ccd or cmos) and can apply a background subtraction methodology to determine whether a vehicle 105 is passing into or out of the parking facility. Note that the background subtraction methodology can also be referred to as foreground subtraction and foreground detection. Edge detection, or other suitable optical sensing means, can be employed in other embodiments.

Referring now to FIG. 2, an example of an automated system for a parking facility such as a parking lot or parking ramp will be described. The description below uses the term “lot” but it should be understood that the present invention can be used for any form of parking facility.

The parking lot 200 comprises a plurality of parking spaces 202. The vehicle entrance 204 and exit 206 to the lot 200 are each monitored with a respective entrance/exit LPR camera device 208, 210 located adjacent to the respective entrance 204 and exit 206. Of course, there can be multiple entry/exit points, each with a corresponding LPR camera device, without departing from the scope of the invention. Each LPR camera device 208, 210 reads the vehicle identification (ID) (e.g. license plate numbers/letters or other characters) of every vehicle entering or exiting the parking lot 200. The decoded vehicle ID is then transmitted and/or stored in memory as described in previous embodiments.

A gate 212 can be optionally provided to the entrance, and a corresponding gate 214 to the exit, to bar passage of a vehicle for various reasons, such as when the lot has reached capacity, or any time a vehicle is not permitted in the lot, or to cause a violator to pay a fine prior to exiting.

A kiosk 216 can be provided to the parking lot 200 in a location convenient to persons parking in the lot. The kiosk 216 can be used to submit payments for parking time, to pay fines, to obtain/provide information, etc. In one example embodiment, a kiosk 216 can be provided at the entrance so that the user can provide their payment information upon entrance to the lot 200. The kiosk can be integrated into the same housing as the LPR camera device. The kiosk 216 can be communicatively coupled (e.g. networked) to the LPR camera device(s) as part of an integrated parking system.

In locations where vehicles have only rear plates, the entrance or exit are correspondingly configured so that the LPR camera devices are placed and aimed so that the rear ID plate can be effectively read. Multiple LPR cameras can also be provided (either in a single housing or in separate housings) to capture and read both the front and rear license plates of each vehicle. A message board 218 can also be provided at the entrance and/or exit of the lot 200 to provide information to users, such as providing information, occupancy status and other messages.

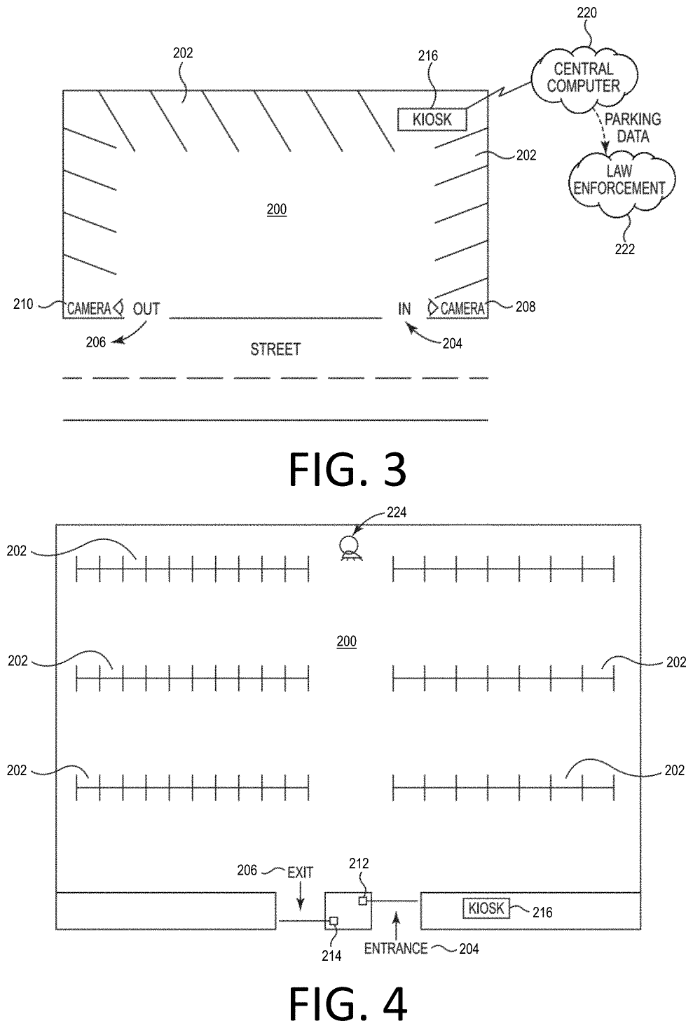

An advantage of certain embodiments is that electromechanical gates can be eliminated, if desired. Such gates are costly and can fail. Referring to FIG. 3, a gateless parking lot system is depicted according to an example embodiment of the invention. This embodiment is directed to parking facilities such as lots, ramps and streets without the use of live enforcement personnel and without gates. In this example, there is shown a parking lot 200 with one entrance 204 and one exit 206 for simplicity of explanation, but multiples of each can be provided. LPR camera devices 208, 210 are placed at the respective entrance 204 and exit 206 of the parking lot 200. A kiosk 216 is also provided to the lot 200. The LPR camera devices 208, 210 are networked with the central computer 220 to report all image data.

The image data from the LPR camera devices 208, 210 can also be relayed to law enforcement systems 222. This allows law enforcement agencies to perform real-time monitoring of who/what is parked where, to compare vehicle ID's (e.g. plates) against a stolen car data base, or compare ID data against a person of interest database, or other analysis related to public safety and security. Such processes could be used by law enforcement for monitoring/investigation of Amber alerts, stolen vehicles, scofflaws, felons and crime prevention, among other security related applications. This law-enforcement coupling embodiment would greatly reduce crime and increase the productivity of law enforcement agencies locally, regionally and nationwide. It would be a unique addition to the intelligence gathering done by police today, and an incremental benefit to the communities served.

In the embodiment, as depicted in FIG. 4, the separate entrance/exit LPR camera devices 208, 210 are replaced with a single LPR camera device 224 mounted at an elevated position above the parking lot 200. The elevated position can be, for example, at the top of a pole in a position that the LPR camera device 224 can see the entrance 204 and exit 206 simultaneously within the camera's fixed field of view. The elevated position allows the LPR camera device 224 to read the license plates of all cars entering and exiting the parking lot. The single camera embodiment reduces the equipment costs and places the LPR camera device 224 in a location with lower likelihood of damage due to vandalism. The LPR camera device 224 can also be equipped with motors to selectively adjust rotation angle (azimuth) and elevation angle. The lens of the LPR camera device 224 can also be equipped with zoom capability.

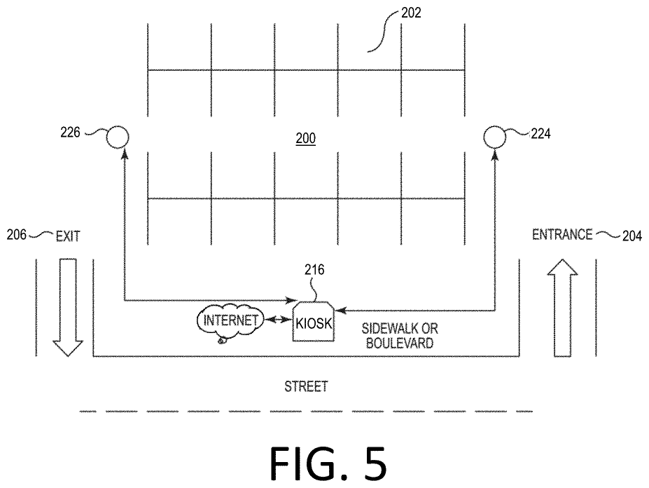

Additional entrances/exits can be monitored with the same single LPR camera device 224, if in that camera's effective field of view. If not in the field of view, then an additional elevated LPR camera device 226 can be utilized as shown in the alternative configuration of FIG. 5. A combination of LPR camera devices at entrance/exit and elevated positions can also be used in further embodiments of the invention. Control gates 212 and 214 at the entrance 204 and exit 206 can be provided as an option.

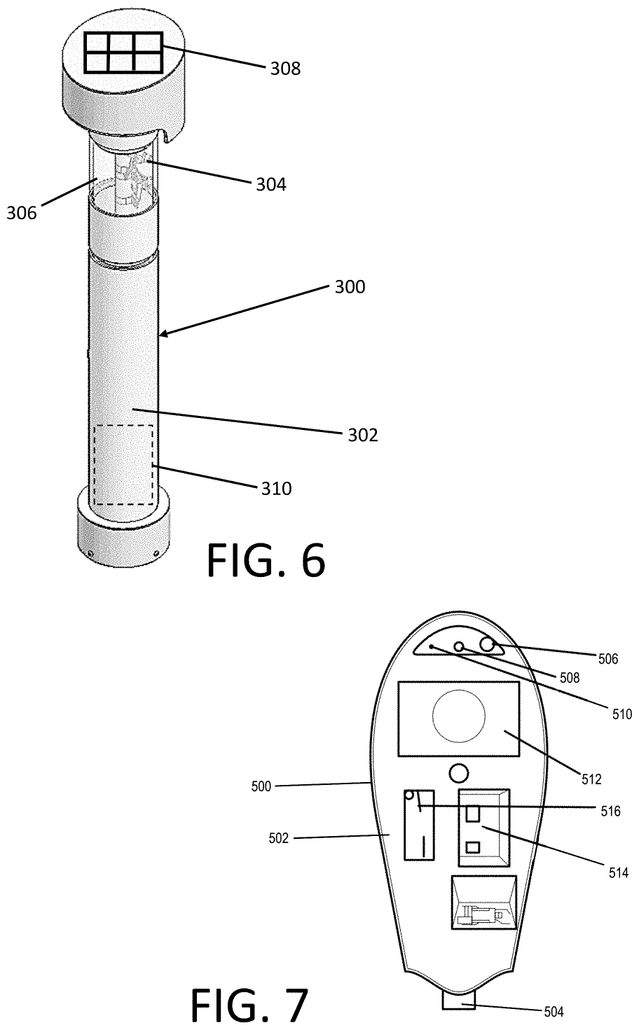

Referring to FIG. 6, the LPR cameras can be housed in a bollard 300. In one example, the bollard 300 comprises an outer enclosure 302 with the LPR camera(s) 304 and other electrical components, such as the microprocessor and memory disposed inside of the enclosure 302. A portion of the enclosure can be transparent (or semi-transparent) which defines a window 306 so that the LPR camera(s) 304 can see the license plates of vehicles passing by the bollard 300. One or more vehicle sensors, as mentioned above, can also be located inside of, or on the exterior of, the enclosure 302. A solar panel 308 can be provided atop the enclosure to generate some or all of the power necessary to operate the LPR cameras 304 and other components of the bollard 300. A battery 310 can also be disposed inside of the enclosure 302 to store energy generated by the solar panel 308 and to power the LPR cameras 304 and other components of the bollard 300. In some embodiments the bollard does not need to be connected to the power grid because the solar panel and onboard battery are sufficient to supply all power needs.

Referring to FIG. 7, an example kiosk 500 is shown. The kiosk comprises an enclosure or housing 502 mounted atop a pole 504. The housing 502 includes the electronics for controlling operation of the kiosk and for networking the kiosk with a central control computer system. The housing 502 includes a speaker 506, a user-facing camera 508 and microphone 510 disposed adjacent to the graphical user interface (e.g. touch screen) 512. A payment acceptance means 514 and coin slot 516 are also provided. The payment acceptance means can be a contactless or conventional card reader, or other known means for accepting payment. The kiosk can also be in a common housing with one or more of the LPR camera devices described above.

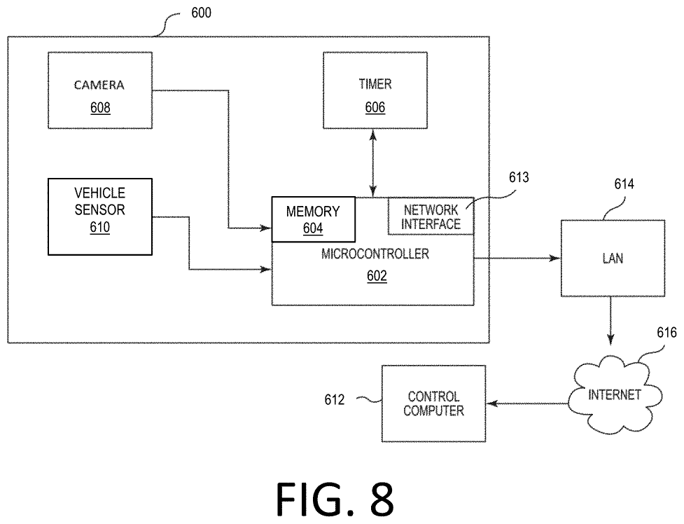

Referring to FIG. 8, a block diagram for certain embodiments of the automated parking system is provided. The LPR camera device 600 includes a microcontroller 602, or microprocessor, with associated physical memory 604. The software code controlling the operation and function of the LPR camera device 600 is stored in the memory 604 and executed by the microcontroller 602. The memory 604 may include one or more non-volatile storage devices and/or one or more volatile storage devices (e.g., random access memory (RAM)).

Computer readable program code is stored in the memory 604, such as, but not limited to magnetic media (e.g., a hard disk), optical media (e.g., an OVO), memory devices (e.g., random access memory, flash memory), etc. The computer readable program code is configured such that when executed by the microcontroller 602, the program code causes the LPR camera device 600 to perform the functions described herein. In other embodiments, the LPR camera device 600 is configured to perform steps described below without the need for code.

A timer 606 is coupled with and controlled by the microcontroller 602. The microcontroller 602 can also count processor clock cycles as a form of timer. The camera 608 (or multiple cameras) is coupled with and in two-way communication with the microcontroller 608. If provided, the vehicle sensor 610 is also operatively connected to the microcontroller 602.

Each LPR camera device 600 is networked with a central or control computer 612. The LPR camera device 600 includes a network interface 613 either integrated into the microcontroller 602, or as a separate component. The network interface 613 is configured to enable communication with a communication network (e.g. a local area network (LAN 614), the Internet or World Wide Web), using a wired and/or wireless connection. Network communication means include, but are not limited to, Wi-Fi, Bluetooth, cellular (HSPA, LTE, GSM,

CDMA), DSL, cable, etc. The LAN 614 may include other LPR camera devices and any kiosk(s), all in communication with one another at a given parking facility. In LAN configuration, the LAN 614 can be connected to the Internet 616 as illustrated in FIG. 8, so that communications with a cloud-based or central control computer system 612 can be accomplished.

The cloud, central or central computer system 612 (hereinafter the control computer) governs the operation of and/or stores the data from a given number of networked LPR camera devices 600 and kiosks. The control computer 612 may comprise one or more servers interfacing with networked storage in a data center. The control computer 612 is located remotely in a secure location for convenience and security purposes. The LAN 614, in turn, is connected to the World Wide Web (i.e. internet) in order to be in communication with a variety of other computing systems, including law enforcement and operations companies. This way, the data can be securely stored and reviewed by appropriate authorities and the operations of all LPR camera device 600 in a given parking system can be monitored and remotely controlled via the control computer 612.

The LPR function can be performed onboard the LPR camera device 600 by the microcontroller 602 using LPR software stored in the memory 604. The LPR function can also be performed by a remotely-located computer system, such as the control computer 618. In such embodiment, the control computer 618 performs the recognition on image data provided by the networked camera device 600.

A decoder can also be included in the LPR camera device to decode an identification where the license plate (or other part of the vehicle) is equipped with a radiofrequency identification (RFID) tag. In addition, the LPR camera device 600 can be programmed to decode machine-readable glyphs and visual encodings, such as barcodes and matrix barcodes (e.g. QR codes), in order to read such encoded items on the vehicle's plate or other portion of the vehicle. Multiple decoding/reading means can be included in a LPR camera device 600 (or multiple separate devices can be provided) to allow the parking system to adapt to a variety of identification methodologies.

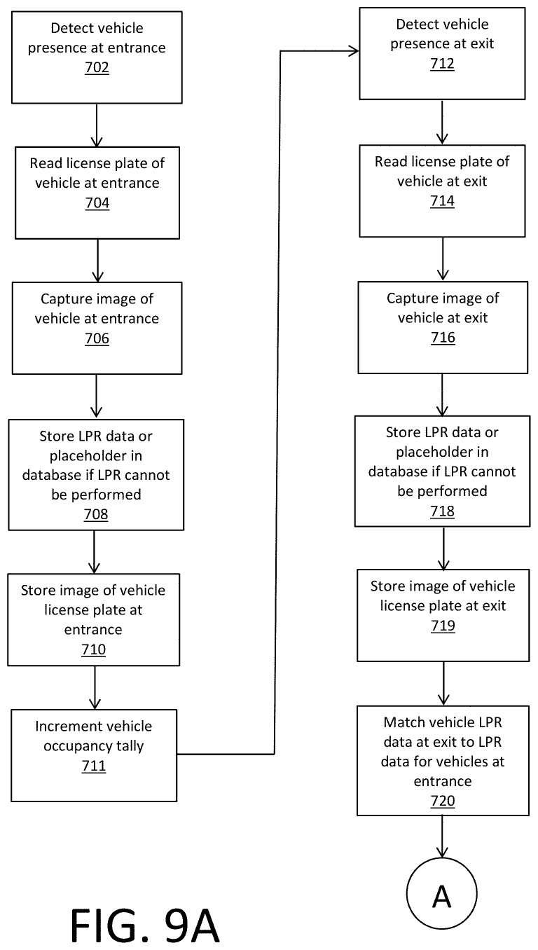

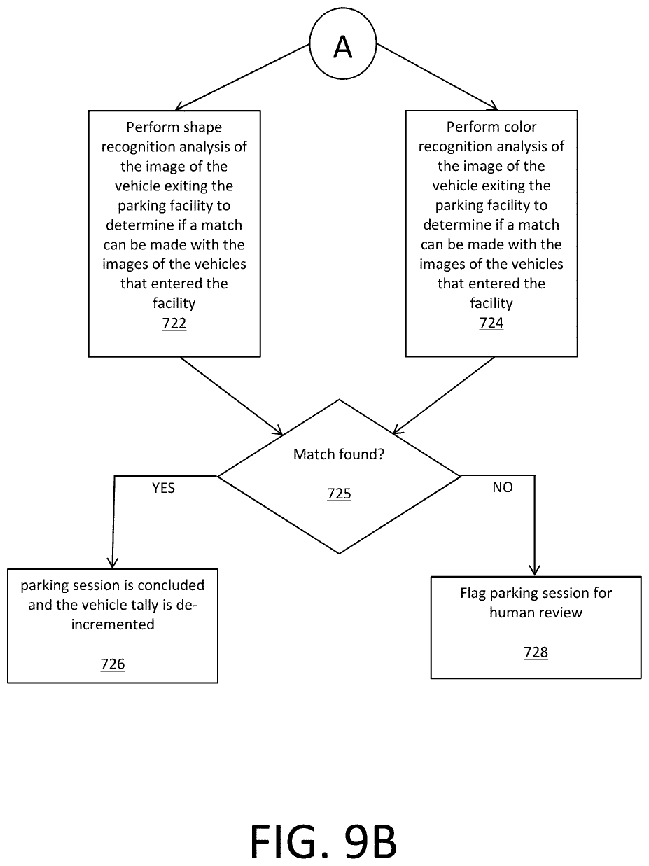

Referring to FIGS. 9A-9B, certain functions and features of the automated parking system will now be discussed according to certain embodiments. When a vehicle approaches the entrance to the parking facility, the LPR camera device detects that a vehicle is present 702. The vehicle's license plate is read via LPR 704, and an image of the vehicle is captured and stored in a database of vehicles entering the parking facility 706. The image of the vehicle is preferably a color image and the entire vehicle's shape is preferably captured.

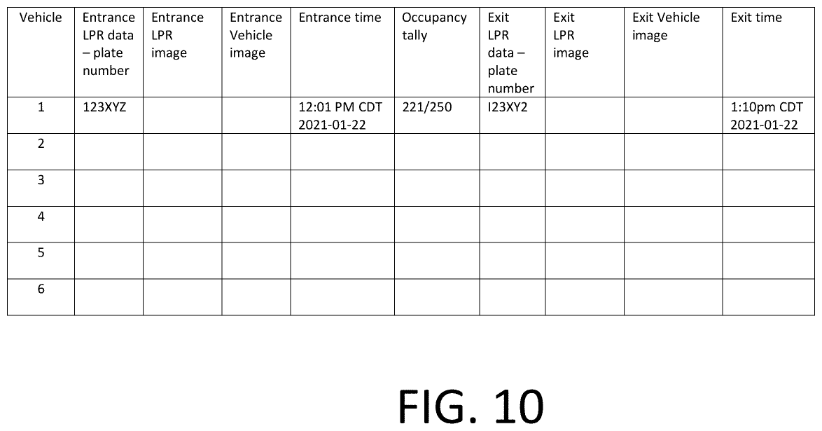

The license plate reading from step 704 is maintained in a vehicle session database so that the license plate data is associated with the corresponding image capture 706 for each vehicle. This allows the automated parking system multiple ways to identify vehicles that exit the parking facility as will be described below. An example of the data structure of such database is shown in FIG. 10.

In FIG. 10, for each vehicle entering the facility, there is an associated data field for 1) the entrance LPR data (decoded plate number), 2) the entrance LPR image, 3) the entrance image of the vehicle (vehicle shape), 4) entrance time, 5) the occupancy tally upon the vehicle entering the facility, 6) the exit LPR data, 7) the exit LPR image, 8) the exit image of the vehicle, and 9) the exit time. All of this data and images can be maintained in memory onboard the LPR camera device, or the data and images can be transmitted to a remote computer, such as the control computer, or the data and images can be maintained in both locations.

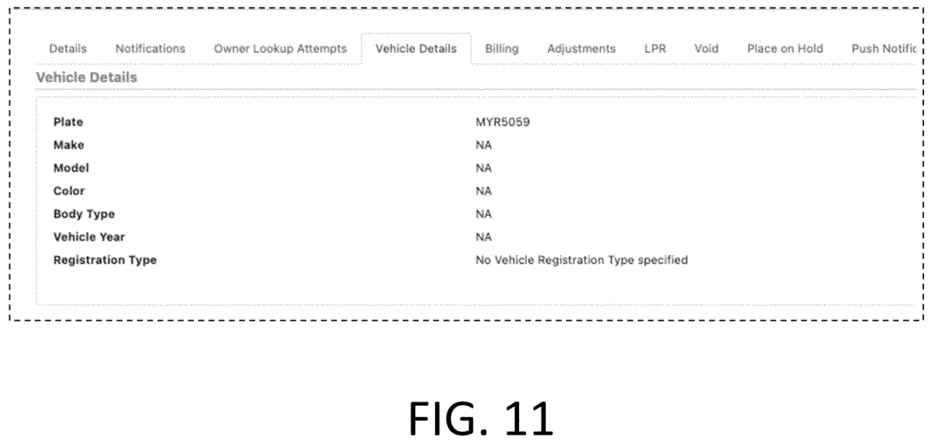

An alternative database example is provided in FIG. 11. As can be seen in this example, additional vehicle detail can be maintained in the database for a given vehicle. Data for the make, model, color, body type, year, etc. can be retrieved from a master database based upon the license plate number. For example, the parking system can interface with government department of motor vehicle databases to look up the vehicle data indicated in FIG. 12. This provides for additional features as will be discussed further herein below.

Referring again to FIGS. 9A-9B, in the event that the vehicle's license plate cannot be read at all by LPR at time of entry into the parking facility, a placeholder notation 708 can be added to the database cell.

An image of the license plate from the entry LPR camera can also be stored in the database 710 and associated with the other entries for that vehicle.

Entry/exit gates can be provided, or the system can be a gateless parking system.

The vehicle occupancy tally for the parking facility is also incremented 711 upon the vehicle entering the parking facility. The tally is monitored to ensure that a maximum occupancy is not exceeded. The tally can be used for other purposes as well. For example, the percentage of utilization can be plotted against time to set parking rates and/or perform parking rate studies. The occupancy tally reaching a set threshold number or percentage can also trigger vehicle control devices to direct vehicle traffic to alternative or overflow parking facilities.

As the vehicle that parked in the parking facility reaches the exit of the facility, the automated system again recognizes the presence of the vehicle 712 and reads the vehicle's license plate via LPR 714. The vehicle full image with color is again captured 716 similar to the entry image capture in step 706. The image from the exit LPR camera device can also be stored for the exiting vehicle 719.

The automated parking system, either by the devices located at the parking lot, or via the control computer, next attempts to match the LPR data from the exit reading to the vehicle data stored in the parking database for that parking facility in order to find a match 720. If a matching entry LPR reading is found, the system can conclude that the vehicle corresponding to a particular parking session has now exited the parking facility. However, if the LPR reading from the vehicle's exit does not match any of the entry LPR readings in the database, or if the LPR upon exit cannot be performed for any reason, the automated parking system proceeds to a secondary analysis of the parking session.

The secondary analysis includes a shape recognition analysis of the image of the vehicle exiting the parking facility 722 to determine if a match can be made with the images of the vehicles that entered the facility. A color evaluation of the vehicle image 724 can be performed as part of the secondary analysis as well. This evaluation is performed by the control computer, or by a device, such as microcontroller of the LPR camera device, located at the parking facility.

If a match using the secondary analysis is found 725, then the parking session is concluded and the vehicle tally is de-incremented 726. If no match can be concluded, then the parking session is flagged for human review 728.

Any one or more of the following steps can be performed by the automated parking system upon the vehicle's exit:
If the vehicle LPR data is missing for one of the entrance or exit events, then the missing license plate data can be filled in automatically with the data obtained from the one successful reading.
In the event that the LPR was successfully performed both at the entrance and the exit, but the LPR determinations did not match (e.g., IZ3XY vs. 123XYZ), then the parking session can be flagged for human review to determine which reading was correct. The human reviewer can then update the parking database accordingly.
In the event that LPR data was missing for both entrance and exit, the parking session can be flagged for human review to determine if a vehicle license plate number or other identification can be discerned. The human reviewer can then update the database accordingly.

If the automated parking system determines that the LPR at either of the entrance or exit cannot be performed, the driver of the vehicle entering and/or exiting the parking facility can be prompted audibly and visually to manually enter their license plate number into a kiosk or other data entry device provided to the parking facility, or the driver can be prompted that a credit card must be provided to a kiosk to enter/exit the parking facility.

In a further alternative embodiment, the secondary analysis step or steps described above can be employed as an additional confirmation step instead of being an alternative identification step for the vehicle. In this embodiment, the steps 722 and/or 724 are performed in addition to step 720 in every exit event to confirm that the vehicle exiting the parking facility matches the vehicle that entered the parking facility. Any disagreement of the identification determinations can be routed to a human reviewer for resolution.

In still a further embodiment, a percentage or partial match of the LPR data in step 720 can be calculated. The partial match data over a certain percentage can be combined with the image analysis results in 722 and/or 724 to increase the likelihood of a correct vehicle match by the automated parking system.

In a further aspect, the vehicle images stored in the parking database can be retrieved as proof of a parking violation in the event that a vehicle owner contests a violation. The images are proof of the vehicle's presence at the time the picture is taken and a time stamp is added and stored accordingly. Thus, it is known that the vehicle was present in the parking facility during the duration of the parking session since the entry and exit are both monitored.

In yet another aspect, the automated parking system can use the vehicle information obtained from a government department of vehicle registration records to verify that the license plate data obtained by the LPR readings matches the official government record data, or vice-versa. For example, if a given license plate is supposed to belong to a vehicle that does not match the image analysis performed on either of the entrance/exit vehicle images 706, 716, then the vehicle and/or its license plate may be stolen. The expected vehicle shape/color for the vehicle according to government records is compared to the shape analysis results performed on the entrance/exit vehicle images 706, 716. The automated parking system, such as control computer, can automatically alert law enforcement personnel in the event that such a discrepancy has been determined.

The license plate data from government records, the LPR data and the vehicle image analysis also allow the automated parking system to facilitate accurate billing or invoicing of parking events to the vehicle owners/permit holders based upon the address of the owner in the official government records. Likewise, parking violations can be sent to the registered address of the vehicle's owner. The violation notices can be sent automatically by the control computer or by a parking enforcement authority that receives notice of the violation from the control computer.

The automated parking system can also be used to improve the management of parking facilities that utilize parking permits. A database of vehicles that correspond to a parking permit for the parking facility can be maintained in a permit database, stored in memory and updated as needed. The permit database contains license plate data and vehicle description data for each permitted vehicle. After a vehicle enters the parking facility 702, the LPR step 704 is performed and the vehicle's image is captured 706. The automated parking system then performs the additional steps of checking the LPR data and analyzing the vehicle's image in an attempt to find a matching vehicle in the permit database. If a match is found, then the parking session proceeds according to the parking permit agreement or rules. If a permitted vehicle match is not found in the permit database, then the parking session proceeds as a timed parking session. These permit checking steps can be repeated upon exit of the vehicle from the parking facility as well.

The camera(s) used for LPR functions can be the same as those used to capture the vehicle image in steps 706/716. Alternatively, the image capturing cameras can be separate cameras and can be located remote from the entrance and/or exit of the parking facility. The camera used to capture the images in steps 706 and 716 can be a common camera, or two separate cameras can be provided for this functionality.

In order to reduce or eliminate the need for a parker to interact with the automated parking system, a parking app on a smartphone can be provided. The app interacts with the control computer to facilitate the financial transaction for the parking session.

In this application the terms “credit card” and “debit card” have been used. It is intended that these terms encompass the entire spectrum of card form payments, including; credit cards, debit cards, smart cards, stored value cards, proprietary parking cards, and parking passes. It will be appreciated by one skilled in that art that there are a variety of payment acceptance mechanisms that can be utilized, whether coin, paper bills, or credit card as described above.

U.S. Pat. No. 10,121,172 B2, U.S. Patent App. Pub. No. 2018/0240337 A1, U.S. Patent App. Pub. No. 2020/0193722 A1, and U.S. Patent App. Pub. No. 2017/0032584 A1 are herein incorporated by reference in their entirety as part of this application.

While the methods, steps, and processing described above and illustrated in the drawings are shown as a sequence of steps, this was done solely for the sake of illustration. Accordingly, it is contemplated that some steps may be added, some steps may be omitted, the order of steps may be re-arranged, and some steps may be performed in parallel.

For purposes of interpreting the claims for the present invention, it is expressly intended that the provisions of 35 U.S.C. § 112(f) are not to be invoked unless the specific terms “means for” or “step for” are recited in a claim.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

What is claimed is:

1. An automated parking system for a parking facility comprising an entrance and an exit, the automated parking system comprising:
a first license plate recognition (LPR) camera device disposed adjacent to the entrance of the parking facility;
a second LPR camera device disposed adjacent to the exit of the parking facility;
a control computer located remote from the first LPR camera device and the second LPR camera device, the control computer networked with the first LPR camera device and the second LPR camera device,
wherein the first LPR camera device is configured to read a license plate of a vehicle entering the parking facility,
wherein the second LPR camera device is configured to read a license plate of the vehicle exiting the parking facility,
wherein at least one of the control computer, the first LPR camera device and the second LPR camera device comprise a parking database to store for every vehicle entering the parking facility the reading of the license plate of the vehicle entering the parking facility, the reading of the vehicle exiting the parking facility, an image of the vehicle entering the parking facility and an image of the vehicle exiting the parking facility,
wherein at least one of the control computer, the first LPR camera device and the second LPR camera device is configured to attempt to compare the reading of the license plate of the vehicle exiting the parking facility to the stored readings of the license plates of vehicles entering the parking facility to find a matching license plate reading, and
wherein, when no match of the license plate reading of the vehicle exiting the parking facility to the stored readings of the license plates of vehicles entering the parking facility can be found, at least one of the control computer, the first LPR camera device and the second LPR camera device are further configured to compare the image of the vehicle exiting the parking facility to the stored images of each of the vehicles entering the parking facility to find a matching vehicle shape and/or color.

2. The automated parking system of claim 1, wherein, when no match of the shape and/or color of the vehicle exiting the parking facility can be found, at least one of the control computer, the first LPR camera device and the second LPR camera device further configured to flag for human review a parking session corresponding to the vehicle entering the parking facility.

3. The automated parking system of claim 1, wherein, when the license plate reading by the first LPR camera device produces a non-read result, at least one of the control computer, the first LPR camera device and the second LPR camera device further configured to fill in a license plate reading data field in the parking database corresponding to the vehicle entering the parking facility with the license plate reading by the second LPR camera device when the shape and/or color of the vehicle exiting the parking facility can be found in the parking database.

4. The automated parking system of claim 1, wherein, when the license plate reading by the second LPR camera device produces a non-read result, at least one of the control computer, the first LPR camera device and the second LPR camera device further configured to fill in a license plate reading data field in the parking database corresponding to the vehicle exiting the parking facility with the license plate reading by the first LPR camera device when the shape and/or color of the vehicle exiting the parking facility can be found in the parking database.

5. The automated parking system of claim 1, wherein, when the license plate reading by both of the first LPR camera device and the second LPR camera device produces a non-read result, at least one of the control computer, the first LPR camera device and the second LPR camera device further configured to flag for human review a parking session corresponding to the vehicle entering the parking facility.

6. The automated parking system of claim 1, wherein, when either of the license plate reading by the first LPR camera device and/or the second LPR camera device produces a non-read result, at least one of the first LPR camera device and the second LPR camera device further configured to provide an audible prompt to the vehicle to manually enter a license plate data for the vehicle.

7. The automated parking system of claim 1, wherein at least one of the control computer, the first LPR camera device and the second LPR camera device is further configured to compare the reading of the license plate of the vehicle entering the parking facility to stored readings of license plates of vehicles stored in a parking permit database.

8. The automated parking system of claim 1, wherein at least one of the control computer, the first LPR camera device and the second LPR camera device is further configured to compare the reading of the license plate of the vehicle entering the parking facility to stored vehicle data from a government department of vehicle registration records to verify that the shape and/or color of the vehicle entering the parking facility matches the official government record for the vehicle entering the parking facility.

9. The automated parking system of claim 1, wherein at least one of the control computer, the first LPR camera device and the second LPR camera device is further configured to calculate a parking fee for a parking duration from a time that the vehicle entered the parking facility to a time that the vehicle exited the parking facility.

10. The automated parking system of claim 1, wherein the first LPR camera device is configured to capture a still image of the vehicle entering the parking facility and the second LPR camera device is configured to capture a still image of the vehicle exiting the parking facility.

11. The automated parking system of claim 1, wherein the first LPR camera device is a bollard, and a camera is disposed inside of the bollard.

12. The automated parking system of claim 1, further comprising a kiosk disposed in the parking facility, the kiosk being networked with the control computer and located remote from the first LPR camera device and the second LPR camera device.

13. A method of automating monitoring of vehicles entering and exiting the parking facility, the method comprising:
reading a license plate of each of the vehicles entering the parking facility with a first LPR camera;
capturing a still image of each of the vehicles entering the parking facility;
storing in a parking database for each vehicle entering the parking facility the license plate reading and the still image corresponding to each vehicle;
reading a license plate of each of the vehicles exiting the parking facility with a second LPR camera;
capturing a still image of each of the vehicles exiting the parking facility;
for each vehicle exiting the parking facility, comparing the vehicle's license plate reading by the second LPR camera with the license plate readings for the vehicles entering the parking facility stored in the parking database to find a matching license plate reading;
when a match of license plate readings is found, storing in the parking database for the vehicle corresponding to the matching license plate reading, the license plate reading for the vehicle exiting the parking facility and the still image for the vehicle exiting the parking facility; and
when a match of license plate readings is not found, comparing the still image of the vehicle exiting the parking facility with the still images captured for the vehicles entering the parking facility stored in the parking database to find a matching still image.

14. The method of claim 13, further comprising, when no match of the still image to the parking database can be found, flagging for human review a parking session corresponding to the vehicle exiting the parking facility whose still image produced no matches.

15. The method of claim 13, further comprising, when the license plate reading by the first LPR camera device produces a non-read result, filling in a license plate reading data field in the parking database corresponding to the vehicle entering the parking facility whose license plate reading produced the non-read result with the license plate reading by the second LPR camera when the still image of the vehicle exiting the parking facility matches the still image of the vehicle entering the parking facility.

16. The method of claim 13, wherein, the step of comparing the still image of the vehicle exiting the parking facility with the still images captured for the vehicles entering the parking facility stored in the parking database to find a matching still image comprises performing an automated machine analysis of a color and/or a shape of the vehicle depicted in each of the still images.

17. The method of claim 13, further comprising, when the license plate reading of both a vehicle entering and exiting the parking facility produces a non-read result, flagging for human review a parking session corresponding to the vehicle corresponding to the non-read results.

18. The method of claim 13, further comprising, when either of the license plate readings produces a non-read result, provide an audible prompt to the vehicle to manually enter a license plate data for the vehicle.

19. The method of claim 13, further comprising comparing by a control computer system networked with the first LPR camera and the second LPR camera the reading of the license plate of the vehicle entering the parking facility to stored readings of license plates of vehicles stored in a parking permit database.

20. The method of claim 13, further comprising comparing by a control computer system networked with the first LPR camera and the second LPR camera the reading of the license plate of the vehicle entering the parking facility to stored vehicle data from a government department of vehicle registration records to verify that the shape and/or color of the vehicle entering the parking facility matches the official government record for the vehicle entering the parking facility.

21. The method of claim 13, further comprising automatically calculating a parking fee for a parking duration from a time that a given vehicle entered the parking facility to a time that the given vehicle exited the parking facility.
